(19) United States
(12) Patent Application Publication
(10) Pub. No.: US 2011/0273121 A1
(43) Pub. Date: Nov. 10, 2011

(54) Electric Machine Component Temperature Monitoring

(75) Inventors: Koon Hoong Wan, Indianapolis, IN (US); Clemens Burger, Noblesville, IN (US); Bradley D. Chamberlin, Pendleton, IN (US)

(73) Assignee: Remy Technologies, LLC, Pendleton, IN (US)

(21) Appl. No.: 13/101,044

(22) Filed: May 4, 2011

Related U.S. Application Data
(60) Provisional application No. 61/331,079, filed on May 4, 2010.

(51) Int. Cl. H02K 11/00; H02P 6/14

(52) U.S. Cl. 318/400.12; 310/68 C; 310/71

(57) ABSTRACT

Embodiments of the invention provide an electric machine module including a module housing. In some embodiments, the module housing can at least partially define a machine cavity into which an electric machine can be positioned. The electric machine can include a rotor assembly comprising a plurality of laminations and a least one magnet positioned substantially within the rotor assembly. In some embodiments, at least one temperature sensor can be operatively coupled to, and in thermal communication with, a portion of the rotor assembly. The temperature sensor can be configured to sense a temperature of the rotor assembly. In some embodiments, at least one transmitter can be in communication with the temperature sensor and can transmit a signal from the temperature sensor to a receiver. In some embodiments, the receiver can be coupled to the module housing and in communication with a controller.

### RELATED APPLICATIONS

This application claims priority under 35 U.S.C. §119 to U.S. Provisional Patent Application No. 61/331,079 filed on May 4, 2010, the entire contents of which is incorporated herein by reference

### BACKGROUND

Efficient operation of an electric machine can improve the lifespan of the motor as well as the electric machine's operating efficiency. For example, some electric machines include permanent magnets and the magnet temperature should be well-controlled because cooler magnets can lead to improved machine performance and maintaining magnets at a cooler temperature can reduce their risk of demagnetization. Machine control based on temperature monitoring can also provide improved operation of the electric machine (e.g., improved control over the electric machine).

### SUMMARY

Some embodiments of the invention provide an electric machine module including a module housing. In some embodiments, the module housing can at least partially define a machine cavity into which an electric machine can be positioned. The electric machine can include a rotor assembly comprising a plurality of laminations and a least one magnet positioned substantially within the rotor assembly. In some embodiments, at least one temperature sensor can be operatively coupled to, and in thermal communication with, at least a portion of the rotor assembly. In some embodiments, the temperature sensor can be configured to sense a temperature of the rotor assembly. In some embodiments, at least one transmitter can be in communication with the temperature sensor and can transmit a signal from the temperature sensor to a receiver. In some embodiments, the receiver can be coupled to the module housing and in communication with a controller.

Some embodiments of the invention provide an electric machine module including a module housing. In some embodiments, the module housing can at least partially define a machine cavity into which an electric machine can be positioned. The electric machine can include a rotor assembly comprising a plurality of laminations and a least one magnet positioned substantially within the rotor assembly. In some embodiments, at least one temperature sensor can be coupled to the rotor assembly and can be configured and arranged to sense a temperature of at least a portion of the rotor assembly. In some embodiments, the temperature sensor can comprise at least one transmitter configured to transmit the sensed temperature to a receiver of a controller. In some embodiments, the controller can be located remote from the machine cavity and can be configured and arranged to control operation of the electric machine at least partially based on the sensed temperature.

### DESCRIPTION OF THE DRAWINGS

FIG. 1 is a cross-sectional view of an electric machine according to one embodiment of the invention.

FIGS. 2A and 2B are cross-sectional views of portions of a rotor assembly according to some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

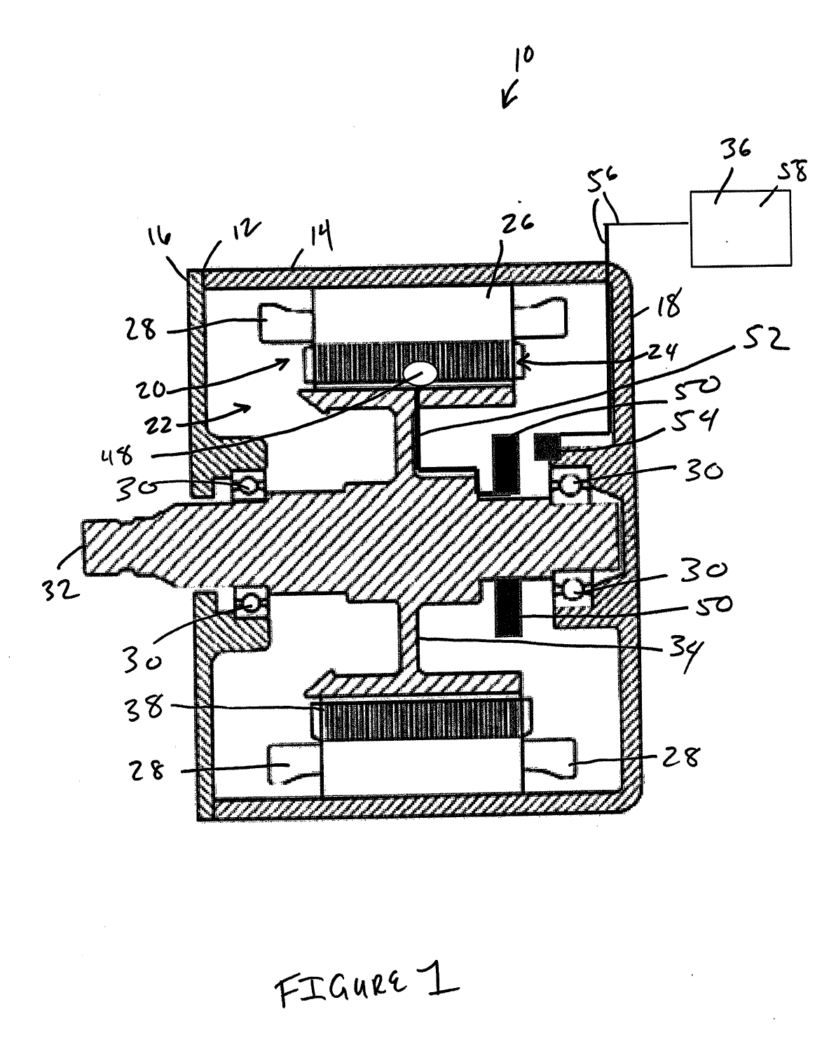

FIG. 1 illustrates an electric machine module 10 according to one embodiment of the invention. The module 10 can include a module housing 12 comprising a sleeve member 14, a first end cap 16, and a second end cap 18. An electric machine 20 can be housed within a machine cavity 22 at least partially defined by the sleeve member 14 and the end caps 16, 18. For example, the sleeve member 14 and the end caps 16, 18 can be coupled via conventional fasteners (not shown), or another suitable coupling method, to enclose at least a portion of the electric machine 20 within the machine cavity 22. In some embodiments, the sleeve member 14 can be formed so that at least one of the end caps 14, 16 is substantially integral with the sleeve member 14. In some embodiments the housing 12 can comprise a substantially cylindrical canister and a single end cap (not shown). Further, in some embodiments, the module housing 12, including the sleeve member 14 and the end caps 16, 18, can comprise materials that can generally include thermally conductive properties, such as, but not limited to aluminum or other metals and materials capable of generally withstanding operating temperatures of the electric machine. In some embodiments, the module housing 12 can be fabricated using different methods including casting, molding, extruding, and other similar manufacturing methods.

The electric machine 20 can be, without limitation, an electric motor, such as a hybrid electric motor, an electric generator, a starter motor, or a vehicle alternator. In one embodiment, the electric machine 20 can be a High Voltage Hairpin (HVH) electric motor or an interior permanent magnet electric motor for hybrid vehicle applications.

The electric machine 20 can include a rotor assembly 24, a stator assembly 26, including stator end turns 28, and bearings 30, and can be disposed about an output shaft 32. As shown in FIG. 1, the stator 26 can substantially circumscribe a portion of the rotor 24. In some embodiments, the rotor assembly 24 can also include a rotor hub 34, or can have a “hub-less” design (not shown). Also, in some embodiments, as described in more detail below, at least one controller 36 can be connected (i.e., physically, electrically, etc.) to at least a portion of the electric machine module 10. In some embodiments, an inner diameter of the rotor assembly 24 can comprise at least one spline (not shown). In some embodiments, the output shaft 32 and/or the input shaft can comprise at least one spline configured and arranged to engage the at least one spline of the rotor assembly 24 to at least partially operatively couple together the rotor assembly 24 and the output shaft 32 and/or an input shaft.

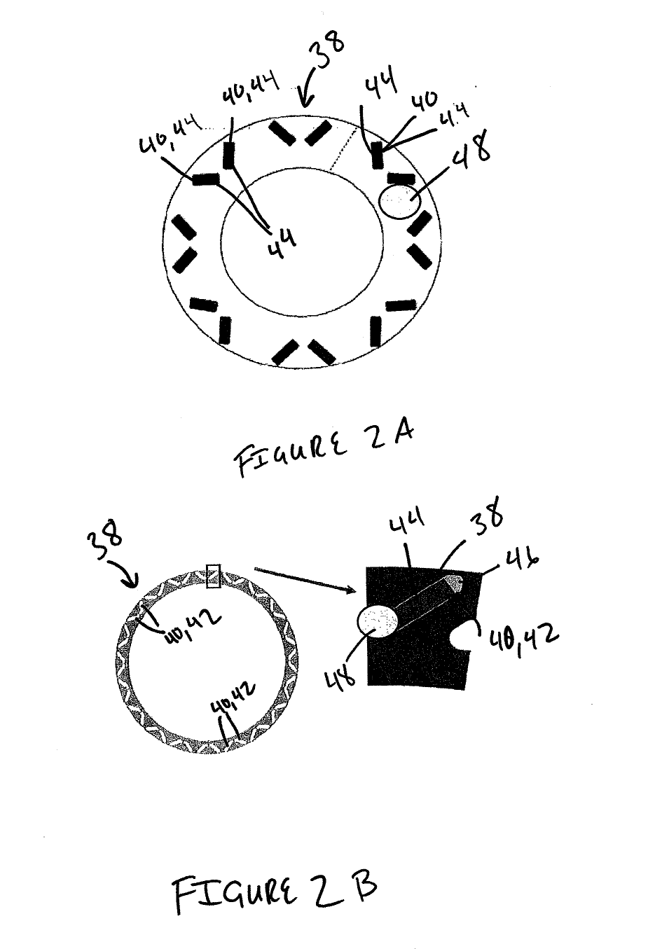

In some embodiments, the rotor assembly 24 can comprise a plurality of rotor laminations 38. As shown in FIGS. 2A and 2B, in some embodiments, at least some of the rotor laminations 38 can include an aperture 40. In some embodiments, the apertures 40 can comprise a generally circular shape, and in other embodiments, the apertures 40 can comprise other shapes such as rectangular, square, slot-like, elliptical, and other regular and/or irregular polygonal shapes. Moreover, in some embodiments, some laminations 38 can include apertures 40 comprising combinations of shapes (i.e., one lamination 38 can include a square aperture, a circular aperture, a rectangular aperture, etc.).

In some embodiments, after the rotor laminations 38 are substantially assembled to form at least a portion of the rotor assembly 24, the apertures 40 can substantially align to form at least one magnet channel 42 so that at least one permanent magnet 44 can be housed substantially within the rotor assembly 24. In some embodiments, the apertures 40 and magnet channels 42 can be configured so that a series of magnetic poles are established after positioning the magnets 44 with in the magnet channels 42. In some embodiments, a filler material 46, such as plastic, steel, steel with a filler metal, etc., can be positioned (i.e., injected or directed) around the magnets 44 to secure the magnets 44 within the magnet channels 42. In some embodiments, the magnets 44 can be coupled to a wall of the magnet channel 42 so that the rotor assembly 24 can function without the filler material 46. For example, in some embodiments, the magnets 44 can be coupled to the wall of the magnet channel 42 using conventional fasteners, adhesives, welding, brazing, and other coupling methods.

According to some embodiments of the invention, the module 10 can comprise at least one temperature sensor 48 in thermal communication with elements of the module 10. Although references to the temperature sensor 48 are singular (i.e., one temperature sensor), in some embodiments, the module 10 can comprise a plurality of temperature sensors 48. In some embodiments, the rotor assembly 24 can comprise the temperature sensor 48. In some embodiments, the temperature sensor 48 can be coupled to at least one of the plurality of rotor laminations 38. For example, in some embodiments, temperature sensor 48 can be coupled to at least one axial side of the rotor assembly 24 (e.g., the axially outmost rotor lamination 38 on either or both axial sides of the rotor assembly). In some embodiments, the temperature sensor 48 can be coupled to the rotor assembly 24 so that the temperature sensor 38 is substantially adjacent to at least one of the magnets 44 of the rotor assembly 24.

In some embodiments, the temperature sensor 48 can be positioned in other locations. In some embodiments, the temperature sensor 48 can be positioned within the rotor assembly 24. For example, in some embodiments, the temperature sensor 48 can be positioned within at least one of the magnet channels 42 substantially adjacent to the magnets 44 (i.e., radially inward from an outer surface of the rotor assembly 24). In other embodiments, the temperature sensor 48 can be coupled to at least one of the magnets 44. For example, in some embodiments, the temperature sensor 48 can be positioned within at least one of the magnet channels 42 immediately adjacent to and/or in contact with at least a portion of at least one of the magnets 44. In some embodiments, after positioning the temperature sensor 48, the magnet channel 42 can be filled with the filler material 36 to substantially retain the temperature sensor 48 in a position immediately adjacent to and/or in contact with the magnet 44. In some embodiments, measuring magnet temperature can at least partially enhance machine 20 operation because by positioning at least one temperature sensor 48 immediately adjacent to and/or in contact with the magnet 44, machine operation can be more accurately controlled. By way of example only, in some embodiments, monitoring of the magnet 44 can at least partially reduce the risk of demagnetization of the magnet 44 because the controller 36, as discussed in further detail below, can adjust operation of the electric machine 20 to at least partially reduce the risk. As discussed in further detail below, in some embodiments, magnet 44 temperature can at least partially impact machine 20 output (e.g., torque production). As a result, by more accurately knowing the magnet 44 temperature, more accurate levels of control over machine 20 operations (e.g., current flowing through the machine 20) can be exerted by the controller 36.

In some embodiments, the temperature sensor 48 can be positioned immediately adjacent to and/or in contact with the magnet 44 and secured in place by other coupling techniques such as welding, brazing, adhesives, conventional fasteners, etc. and the machine 20. Also, in some embodiments, the temperature sensor 48 can be coupled to a portion of the magnet 44 at an axial end of the magnet channel 42 (i.e., at an axial end of the magnet channel 42 immediately adjacent to the machine cavity 22).

In some embodiments, the temperature sensor 48 can be positioned substantially within the rotor assembly 24. In some embodiments, during operation of the electric machine 20, the magnets 44 positioned within the rotor assembly 24 can transfer at least a portion of their heat energy directly to the plurality of rotor laminations 38. As a result, in some embodiments, measuring the temperature of a portion of some of the rotor laminations 38 can at least partially serve as a proxy for directly measuring the magnet 44 temperature. Accordingly, in some embodiments, the temperature sensor 48 can be positioned within a portion of the rotor assembly 24 (i.e., embedded within the plurality of rotor laminations 38) so that the temperature sensor 48 can sense a temperature of the magnets 44 without being substantially immediately adjacent to and/or in contact with the magnets 44. Also, in some embodiments, the temperature sensor 48 can be coupled to a portion of the rotor hub 34. In some embodiments including multiple temperature sensors 48, the sensors 48 can be positioned in any combination of the previously mentioned locations. Moreover, in some embodiments, the temperature sensor 48 can sense a temperature of an area to which it is coupled and adjacent areas (e.g., magnets 44, rotor laminations 38, the rotor hub 34, the rotor assembly 24, etc.).

In some embodiments, the temperature sensor 48 can be coupled to the rotor assembly 24 in different manners. For example, in some embodiments, the temperature sensor 48 can be coupled by brazing, welding, adhesives, conventional fasteners, friction fitting, retained in position by the filler material 36, a combination thereof, or other coupling methods. Moreover, in some embodiments, the temperature sensor 48 can be substantially integral with respect to the rotor laminations 38, the magnets 44, the rotor hub 34, and/or the output shaft 32. Also, in some embodiments, the temperature sensor 48 can be positioned so that it can substantially synchronously rotate with the rotor assembly 24.

In some embodiments, the temperature sensor 48 can comprise at least one transmitter 50. In some embodiments, the transmitter 50 and the temperature sensor 48 can be substantially integral (i.e., one structure can comprise the temperature sensor 48 and the transmitter 50). In some embodiments, the transmitter 40 can be generally remote relative to the temperature sensor 48. As shown in FIG. 1, in some embodiments, a first lead 52 can connect the temperature sensor 48 and the transmitter 50. In some embodiments, the temperature sensor 48 can be coupled to the rotor assembly 24 and the transmitter 50 can be coupled to a remote location (i.e., the output shaft 32, dynamically and/or slidably coupled to an inner wall of the module housing 12, etc.) and at least one first lead 52 can connect the two so that the sensed temperature processed by the temperature sensor 48 can be communicated to the transmitter 50. For example, in some embodiments, the transmitter 50 can be disposed about the output shaft 32 and/or immediately adjacent to the output shaft 32, and can rotate substantially synchronously with the output shaft 32 during operation of the machine 20, as shown in FIG. 1. In some embodiments, if the transmitter 50 is positioned immediately adjacent to the output shaft 32 and rotates with the output shaft 32, it can experience a lesser rotational velocity the closer that the transmitter 50 is positioned to the output shaft 32 relative to elements of the module 10 positioned a greater radial distance from the output shaft 32. In some embodiments, the lead 52 can be secured to portions of the electric machine 20 and/or the module housing 12 so that, during operation of the electric machine 20, the lead 52 does not interfere with movement of the module 10 components. In some embodiments, multiple temperature sensors 38 can be connected to one transmitter 50 or multiple transmitters 50 via one or more leads 52. Further, as shown in FIG. 1, in some embodiments, the transmitter 50 can be positioned generally within the machine cavity 22, and in other embodiments, the transmitter 50 can be positioned generally outside of the machine cavity 22 (e.g., between the machine cavity 22 and the module housing 12 or substantially outside of the module housing 12).

In some embodiments, the transmitter 50 can transmit temperature data received from the temperature sensor 48 to at least one receiver 54. In some embodiments, the transmitter 50 can transmit the temperature data to the receiver 54 via radio-frequency identification (RFID) technology or other methods of wireless and/or hard-wired communication. As shown in FIG. 1, in some embodiments, the receiver 54 can be positioned substantially within the machine cavity 22 and/or substantially adjacent to the transmitter 50. In some embodiments, the receiver 54 can be coupled a portion of the module housing 12. For example, in some embodiments, the receiver 54 can be positioned between about 2 and about 10 millimeters away from the transmitter 50, however, in other embodiments, the receiver 54 can be positioned in other locations at other distances away from the transmitter 50. In other embodiments, the receiver 54 can be can be positioned generally outside of the machine cavity 22 (i.e., between the machine cavity 22 and the module housing 12 or substantially outside of the module housing 12). As a result, in some embodiments, the transmitter can wirelessly transmit temperature data through the machine cavity 22 and/or portions of the module housing 12. Further, in some embodiments, the module 10 can comprise multiple receivers 54 positioned within the machine cavity 22 and/or outside of the module housing 12 to receive sensed temperature data from at least one transmitter 50.

As shown in FIG. 1, in some embodiments, the receiver 54 can be in communication with the controller 36 via at least one second lead 56. In some embodiments, the controller 36 can be positioned at a location remote to the module housing 12 so that, depending on the location of the receiver 54, the second lead 56 can extend from the receiver 54, through a portion of the module housing 12, and then connect to the controller 36. In some embodiments, the receiver 54 can be positioned substantially outside of the module housing 12 so that the second lead 56 need not extend through a portion of the module housing 12. Also, in some embodiments, both the receiver 54 and the controller 36 can be positioned substantially within the module housing 12 so that the second lead 56 need not extend through a portion of the module housing 12. In some embodiments, the controller 36 can receive the sensed temperature data substantially in real-time or near real-time from the temperature sensor 48.

In some embodiments, the controller 36 can comprise the receiver 54 so that the module 10 can function substantially without the second lead 56 (i.e., the transmitter 50 can transmit temperature data directly to the receiver 54 of the controller 36). Moreover, in some embodiments, the receiver 54 can be in communication with at least one other transmitter (not shown), which can then transmit the sensed temperature data to at least one other receiver (i.e., a “daisy-chain configuration” configured to at least partially extend a distance between the temperature sensor 48 and the controller 36). Also, in some embodiments, the controller 36 can be in communication with the temperature sensor 48 so that the controller 36 via a third lead wire (not shown) so that the controller 36 can directly receive temperature data from the temperature sensor 48 without the receiver 54 and/or the transmitter 50.

In some embodiments, the controller 36 can comprise at least one look-up table 50 and/or other systems to control operation of the electric machine 20. In some embodiments, before initial operation of the electric machine 20, the look-up table 58 can be populated during calibration. More specifically, in some embodiments, prior to initial operation of the electric machine 20, the look-up table 58 can be populated by determining control parameters needed to achieve a given machine 20 output. For example, during calibration, it can be determined that for the electric machine 20 to output 100 Newton-meters (Nm) of torque, a certain amount of current and/or control angle must be applied to the electric machine 20. In addition, in some embodiments, because the temperature also can at least partially impact electric machine 20 performance and torque output, during calibration, temperature data can also be measured as another operational parameter affecting output, in addition to current and/or control angle. Then, in some embodiments, the look-up table 58 can be populated by determining, temperature, current, and/or control angle required to drive the electric machine 20 to output different levels of torque. As a result, in some embodiments, the look-up table 58 can comprise at least the previously mentioned operational parameters.

In some embodiments, the controller 36 and temperature sensor 48 can lead to generally more accurate electric machine 20 output. In some embodiments, because the electric machine 20 can operate on a generally open-loop control system, accurate control of machine 20 output can be important for machine 20 operations, and by increasing the number of operational parameters in the look-up table 58, the machine 20 can be more generally accurately controlled. Conventionally, a look-up table 58 may substantially lack temperature as an operational parameter and, as a result, the electric machine 20 may not be accurately controlled. For example, in some embodiments, the controller 36 can determine that 100 Nm of output torque can be necessary for efficient machine 20 operation in a given operational condition and the controller 36 can retrieve the corresponding current and/or control angle from the look-up table 58 to create that required of torque. Conventionally, the operating parameters stored in a look-up table for 100 Nm of torque may produce 100 Nm at 120° C. temperature, but only 102 Nm at 80° C. or 95 Nm at 150° C. In some embodiments, by including temperature in the look-up table 58 and by receiving substantially real-time temperature data from the temperature sensor 48, the controller 36 can select a current and/or control angle that can more accurately lead to the desired torque output.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. An electric machine module comprising:
a module housing at least partially defining a machine cavity;
an electric machine positioned in the machine cavity and at least partially enclosed by the module housing, the electric machine including a rotor assembly and an output shaft, the rotor assembly including a plurality of laminations and at least one magnet positioned substantially within the rotor assembly and operatively coupled to the output shaft;
at least one temperature sensor operatively coupled to a portion of the rotor assembly, the at least one temperature sensor in thermal communication with the rotor assembly and configured and arranged to sense a temperature of a portion of the rotor assembly;
at least one transmitter in communication with the at least one temperature sensor and operatively coupled to at least one of the rotor assembly and the output shaft, the at least one transmitter configured and arranged to transmit a signal from the at least one temperature sensor, the signal comprising the rotor assembly temperature sensed by the at least one temperature sensor;
at least one receiver coupled to a portion of the module housing, the at least one receiver configured and arranged to receive the signal from the at least one transmitter; and
a controller in communication with the at least one receiver, the at least one receiver configured and arranged to relay the wireless signal received from the transmitter to the controller.

2. The electric machine module of claim 1, wherein the rotor assembly comprises a rotor hub, the rotor hub operatively coupled to the output shaft, and the at least one temperature sensor operatively coupled to the rotor hub.

3. The electric machine module of claim 1 and further comprising at least one first lead connecting the at least one temperature sensor and the at least one transmitter, the at least one first lead configured and arranged to transmit the signal between at least one temperature sensor and the at least one transmitter.

4. The electric machine module of claim 1, wherein the at least one transmitter and the at least one receiver are configured and arranged to communicate via radio-frequency identification technology.

5. The electric machine module of claim 4, wherein the at least one receiver is coupled to an outside portion of the module housing.

6. The electric machine module of claim 1 and further comprising at least one second lead connecting the at least one receiver and the at least one controller, the at least one second lead configured and arranged to transmit the signal between the at least one receiver and the at least one controller.

7. The electric machine module of claim 1, wherein the controller further comprises a look-up table.

8. The electric machine module of claim 7, wherein the look-up table comprises a plurality of electric machine operational parameters.

9. The electric machine module of claim 1, wherein the at least one temperature sensor is immediately adjacent to the at least one magnet.

10. The electric machine module of claim 1 and further comprising a plurality of temperature sensors.

11. An electric machine module comprising
a module housing at least partially defining a machine cavity;
an electric machine positioned in the machine cavity and at least partially enclosed by the module housing, the electric machine including a rotor assembly and an output shaft, the rotor assembly including a plurality of laminations, at least one magnet positioned substantially within the rotor assembly, and a rotor hub, and the rotor hub operatively coupled to the output shaft;
at least one temperature sensor coupled to the rotor assembly and configured and arranged to sense a temperature of a portion of the rotor assembly, the at least one temperature sensor comprising at least one transmitter configured and arranged to transmit the sensed temperature to a receiver of a controller; and
wherein the controller is located remote from the machine cavity and configured and arranged to control operation of the electric machine at least partially based on the sensed temperature.

12. The electric machine module of claim 11, wherein the at least one transmitter and the receiver of the controller are configured and arranged to communicate via radio-frequency identification technology.

13. The electric machine module of claim 11 and further comprising at least one first lead connecting the at least one temperature sensor and the at least one transmitter.

14. The electric machine module of claim 12, wherein the at least one transmitter is operatively coupled to at least one of the rotor assembly and the output shaft.

15. The electric machine of claim 11, wherein the controller comprises a look-up table.

16. The electric machine module of claim 15, wherein the look-up table comprises a plurality of electric machine operational parameters.

17. The electric machine module of claim 11, wherein the at least one temperature sensor is immediately adjacent to the at least one magnet.

18. A method for controlling an electric machine, the method comprising:
providing a module housing at least partially defining a machine cavity;
positioning an electric machine substantially within the machine cavity so that the electric machine is at least partially enclosed by the module housing, the electric machine including a rotor assembly, the rotor assembly comprising a plurality of laminations and at least one magnet;
coupling at least one temperature sensor to the rotor assembly, the at least one temperature sensor configured and arranged to sense a temperature of a portion of the rotor assembly;
coupling at least one transmitter to a portion of the electric machine, the at least one transmitter in communication with the at least one temperature sensor and configured and arranged to transmit the sensed temperature to a receiver of a controller; and
positioning the receiver and the controller remote from the machine cavity, the controller configured and arranged to control operation of the electric machine at least partially based on the sensed temperature.

19. The method of claim 18, wherein the controller comprises a look-up table comprising a plurality of electric machine operational parameters.

20. The method of claim 19 and further comprising calibrating the electric machine to populate the look-up table with the plurality of electric machine operations parameters.
